(19) United States
(12) Patent Application Publication
(10) Pub. No.: US 2026/0091379 A1
(43) Pub. Date: Apr. 2, 2026

(54) METHOD FOR PRODUCING CARBON DIOXIDE ABSORBENT AND DESULFURIZATION CATALYST

(71) Applicant: Won Bang HONG, Seoul (KR)

(72) Inventors: Won Bang HONG, Seoul (KR); Moo Shin PARK, Yangju-si (KR); Jeong Hwan HONG, Seoul (KR); In Young CHANG, Seoul (KR); Kyeong Jae SHIN, Incheon (KR)

(21) Appl. No.: 18/993,808

(22) PCT Filed: Jul. 17, 2023
(86) PCT No.: PCT/KR2023/010172

§ 371 Date: Jan. 13, 2025

(30) Foreign Application Priority Data
Jul. 19, 2022 (KR) 10-2022-0089132

(51) Int. Cl. B01J 37/03; B01D 53/14; B01D 53/62; B01D 53/78; B01D 53/86; B01J 21/16; B01J 37/00

(52) U.S. Cl. CPC B01J 37/031; B01D 53/1475; B01D 53/1493; B01D 53/62; B01D 53/78; B01D 53/8609; B01J 21/16; B01J 37/009; B01D 2251/306; B01D 2251/602; B01D 2257/504; B01D 2258/0283

(57) ABSTRACT

The present invention relates to a method for producing a carbon dioxide absorbent and a desulfurization catalyst, the method comprising the steps of: (S10) introducing an illite powder into a reaction bath storing water heated to 40 to 100° C., followed by stirring; (S20) introducing sodium hydroxide into the reaction bath, followed by stirring; (S30) separating and filtering a supernatant from the reaction bath; and (S40) separating a precipitate from the reaction bath.

### TECHNICAL FIELD

The present invention relates to a method for producing an absorbent capable of removing sulfur oxides and carbon dioxide from exhaust gas at a power plant and a method for producing a desulfurization catalyst.

### BACKGROUND ART

Power plants and the like using fossil fuels contain large amounts of CO₂ in exhaust gas after combustion. NOx generated due to a high-temperature combustion process is removed by denitrification equipment (SCR or SNCR). In addition, even when the relatively expensive LNG power generation is excluded, first, SOx is generated after combustion due to sulfur ingredients in the fuel depending on a type of the fossil fuel used as the fuel, and dusts containing ash and heavy metals are removed in an electrostatic precipitator (EP).

Large-scale flue gas desulfurization (FGD) facilities are operated to suppress SOx emissions into the atmosphere, and sulfur ingredients are removed in the form of CaSO₄ by using limestone as an absorbent from a large absorption tower. These exhaust gases contain CO₂ (366 tons/hr, based on a 500 MWH power plant), which is more than 100 times the amount of SOx generated and removed, and are being emitted into the atmosphere without processing (2.6 million tons/year, based on 366 tons/hr*24 hours*300 days).

In order to remove or reduce such a huge amount of CO₂, it may be impossible in terms of scale to construct and operate facilities using absorbents such as limestone, and wastewater generation may also be enormous.

Thus, there is a need to develop adsorbents that have excellent adsorption ability for carbon dioxide and enable low-cost CO₂ degastification or easy resource conversion from a facility which is realizable in terms of economic feasibility and scale. In addition, it is preferable to enable a circulation system for the adsorbents to minimize additional chemical costs and suppress wastewater generation.

Even when most of various ingredients contained in the fuel are removed in the EP, the above CO₂ resource circulation system is still contaminated with dusts or sulfur oxides containing heavy metals in the exhaust gas, and thus, the purity issue is required to be resolved to remove various impurities when attempting to convert captured carbon dioxide into a resource.

Korean Patent Registration No. 10-1415865 for a patent document discloses the technology serving as the background art of the present invention.

### DISCLOSURE

### Technical Problem

In order to solve the above problems, the present invention provides a method for producing a carbon dioxide absorbent capable of efficiently removing carbon dioxide as well as sulfur oxides from exhaust gas, and a method for producing a desulfurization catalyst.

### Technical Solution

The method for producing a carbon dioxide absorbent and a desulfurization catalyst according to the present invention for achieving the above object (hereinafter referred to as “the producing method of the present invention”) includes the steps of: (S10) introducing an illite powder into a reaction bath storing water heated to 40° C. to 100° C., followed by stirring; (S20) introducing sodium hydroxide into the reaction bath, followed by stirring; (S30) separating and filtering a supernatant from the reaction bath; and (S40) separating a precipitate from the reaction bath.

Before S20 step, an example further includes adding sodium tetraborate to the reaction bath, followed by stirring (S10-1).

After step S20, an example further includes adding water glass to the reaction bath, followed by stirring (S20-1).

After step S20-1, an example further includes adding hydrogen peroxide to the reaction bath, followed by stirring (S20-2).

After step S40, an example further includes mixing an additive including a surfactant and an oxyacid into the separated precipitate (S40-1).

As an example, step S40-1 includes further adding precipitated carbonate.

### Advantageous Effects

As described above, according to the producing method of the present invention, a carbon dioxide absorbent capable of absorbing and removing large amounts of carbon dioxide as well as sulfur oxides from exhaust gases from power plants and the like can be produced.

In addition, a pre-combustion desulfurization catalyst as a fuel additive can be produced at the same time a carbon dioxide absorbent can be produced.

### DESCRIPTION OF DRAWINGS

FIG. 1 is a block diagram showing a producing method of the present invention.

FIG. 2 is a view showing a carbon dioxide absorption mechanism in the present invention.

FIG. 3 is a graph showing an experimental result on the removal of sulfur oxides.

FIG. 4 is a graph showing an experimental result on the removal of carbon dioxide.

### BEST MODE

### Mode for Invention

Hereinafter, preferred embodiments according to the present invention will be described in detail.

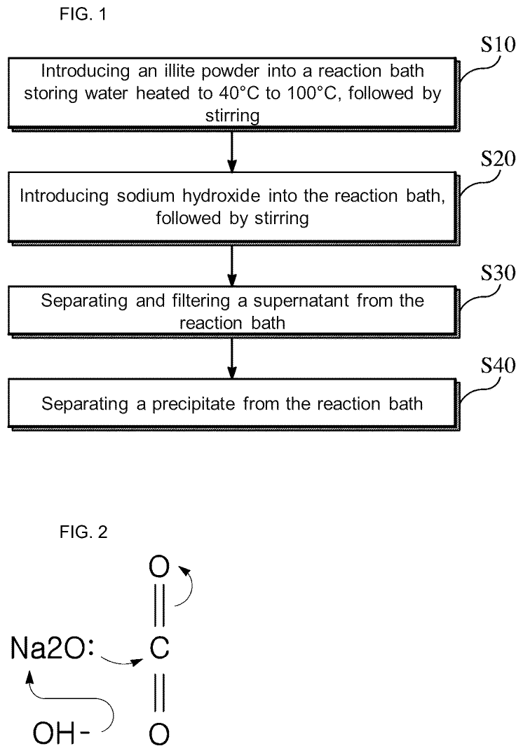

As shown in FIG. 1, the producing method of the present invention includes the steps of: (S10) introducing an illite powder into a reaction bath storing water heated to 40° C. to 100° C., followed by stirring; (S20) introducing sodium hydroxide into the reaction bath, followed by stirring; (S30) separating and filtering a supernatant from the reaction bath; and (S40) separating a precipitate from the reaction bath.

First, step S10 includes introducing an illite powder into a reaction bath storing water heated to 40° C. to 100° C., followed by stirring.

An illite extract is obtained through step S10, in which the illite is a mineral that is expressed as {K_{0.75} [Al_{1.75} (Mg·Fe₂₊)_{0.25}](Si_{3.50}Al_{0.50})O₁₀(OH)₂} and has been found to be buried in large quantities in the Yeongdong region of South Korea. A layer charge is lower compared to muscovite, and the charge is due to the isomorphous substitution decrease of Al³⁺ and Si⁴⁺ in a tetrahedral plate. The isomorphic substitution slightly occurs in an octahedral plate. Illite is non-expandable due to the strong bonding force caused by K+ present between layers, and an interlayer spacing is 10 Å.

Accordingly, illite is a mineral extracted from a liquid state so as to be fully charged with positive ions and easily converted into a chelation-bonding compound. According to the present invention, it is reasonable to use undifferentiated illite to easily extract the above metal foreign substance.

The extract extracted from illite is a liquid extract containing several kinds of metal oxides such as potassium oxide to provide a mineral easily converted into a chelation-bonding compound in a liquid state so as to serve as a reaction promoter in the absorption reaction of carbon dioxide and sulfur oxide in a sodium hydroxide aqueous solution described later.

In other words, the illite extract is further added to increase the absorption efficiency in the absorption of carbon dioxide containing SOx in the sodium hydroxide aqueous solution.

Next, it includes a step (S20) of introducing sodium hydroxide into the reaction bath, followed by stirring.

In this manner, the illite extract is mixed into the sodium hydroxide aqueous solution. The sodium hydroxide aqueous solution has a feature of simultaneously removing carbon dioxide having high temperature and high concentration and mixed gas containing COS (hydrocarbons, O₂ and SOx). In other words, sulfur oxides (SOx) and carbon dioxide are simultaneously absorbed from power plant exhaust gas.

The principle that sulfur oxides and carbon dioxide are removed by the sodium hydroxide aqueous solution is as shown in the following reaction formula.

In other words, sulfur trioxide (sulfurous acid) and sulfur dioxide are removed when being reacted with sodium hydroxide and extracted into anhydrous sodium sulfate and sodium sulfite, respectively, as shown below. In addition, carbon dioxide is removed when being reacted with sodium hydroxide to generate sodium carbonate, as shown in the following reaction formula.

In addition, the generated sodium carbonate may be reacted with excess sulfur oxides to further increase the removal effect of sulfur oxides, and the generated carbon dioxide may be removed by sodium hydroxide.

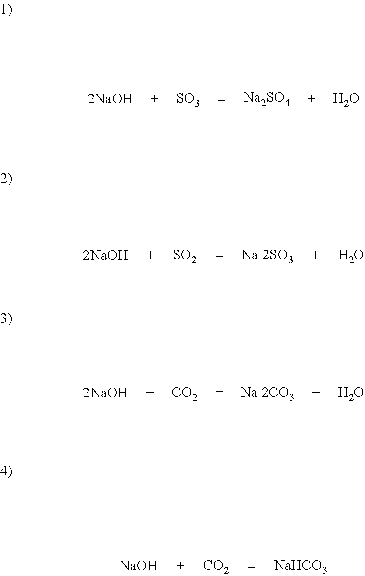

In addition, as mentioned above, the reaction formula of sodium hydroxide and the illite extract as a reaction promoter is as follows. Only the main ingredients of Illite are described, and oxides of other trace ingredients such as Ca, Fe, Mg, Mn, Ti and P₂O₅ also contribute significantly to the formation of stable metal chelation compounds in the liquid state.

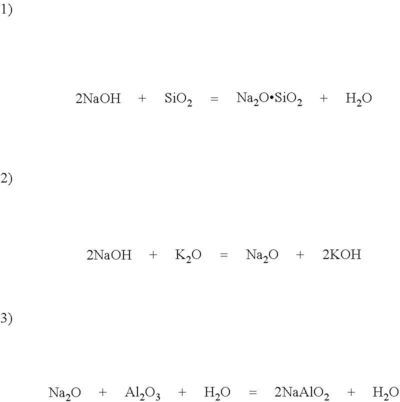

In addition, according to the present invention, before step S20, an example further includes adding sodium tetraborate to the reaction bath, followed by stirring (S10-1). In addition, after step S20, an example further includes adding water glass to the reaction bath, followed by stirring (S20-1).

In other words, an example further includes adding sodium tetraborate (Na 2B 4O 7·10H 2O) and water glass (Na₂SiO₃) to the illite extract and the sodium hydroxide aqueous solution.

The sodium tetraborate and the water glass are added to the sodium hydroxide aqueous solution in addition to the illite extract. When the sodium tetraborate and the water glass are added in the above manner, the carbon dioxide and absorbent components are directly reacted, so that the reaction rate becomes much faster and the mass transfer coefficient also increases.

Moreover, because the sodium tetraborate and the water glass have high viscosity, absorbed carbon dioxide in a gaseous state fails to escape and quickly dissolves into a liquid state so as to be reacted as carbonic acid, thereby doubling the carbon dioxide absorption rate.

In addition, according to the present invention, after step S20-1, an example further includes adding hydrogen peroxide to the reaction bath, followed by stirring (S20-2).

In other words, an example is presented in which hydrogen peroxide (H₂O₂) is further added as a reaction-promoting additive.

The reaction formula of sodium tetraborate and hydrogen peroxide in the sodium hydroxide aqueous solution is as follows.

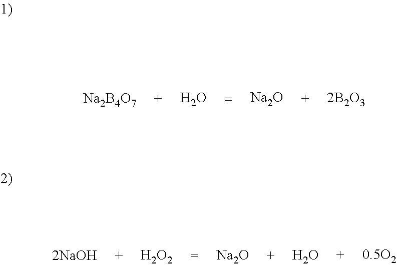

Thus, the carbon dioxide absorption mechanism is as shown in FIG. 2 and the following reaction formula.

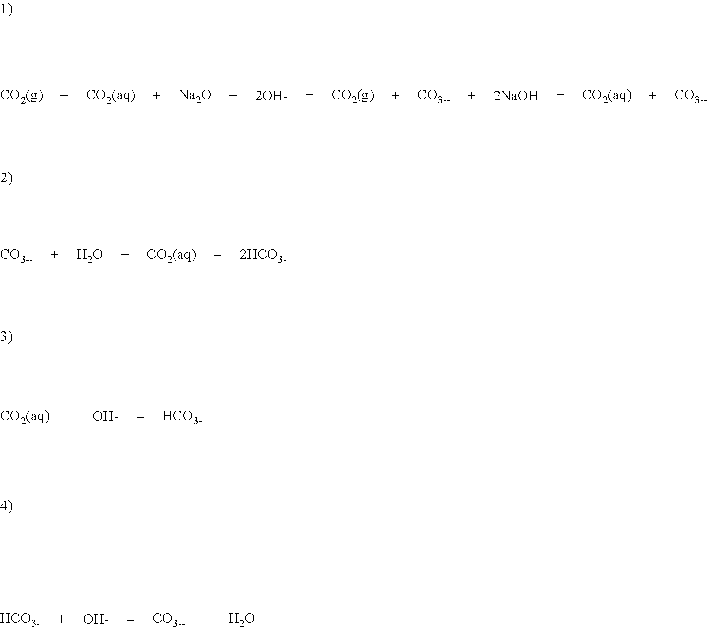

After the reaction is completed in the above manner, a next step (S30), of separating and filtering the supernatant from the reaction bath, proceeds. The supernatant is separated from the reaction bath, and foreign substances contained in the supernatant are removed, so that a carbon dioxide absorbent is produced.

Next, a step (S40), of separating a precipitate from the reaction bath, proceeds. The pre-combustion desulfurization catalyst is produced by separating the precipitate.

The precipitate in the reaction bath contains ingredients extracted from illite or the like and includes various types of metal salts such as Ca, Fe, Mg, Mn, and Ti.

The precipitate separated by these active ingredients in the above manner may be added to fuel before combustion and used as a desulfurization catalyst, and it can be seen to serve as a combustion aid based on the experimental results showing that the amount of CO₂ generated in the exhaust gas increases from 14% more or less to 17% under the same combustion conditions although not specifically described in Experimental Example 3 below.

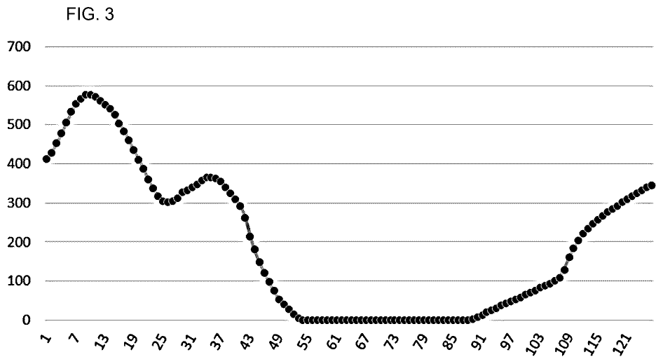

The supernatant obtained from the reaction bath is a sodium hydroxide liquid containing illite active ingredients, sodium tetraborate and water glass, and may be used as a pre-combustion fuel-added desulfurization catalyst. FIG. 3 shows the desulfurization ability of fuel to which the produced solution is added.

In addition, after step S40, mixing an additive including a surfactant and an oxyacid into the separated precipitate (S40-1) may be further included.

The above separated precipitate, that is, the metal salt aqueous solution, is configured to contain the additive including the surfactant and the oxyacid.

The surfactant serves as a dispersant so that the desulfurization catalyst has a large surface area, and it is preferable to use a nonionic surfactant. The nonionic surfactant refers to a surfactant that does not have a group dissociating into ions in an aqueous solution and has an —OH group. Although having relatively little hydrophilicity, it has ester, acid amide, and ether bonds within the molecule.

The nonionic surfactants include an ether type, an ester ether type, an ester type, and a nitrogen-containing type. Examples of the ether type surfactant include alkyl and alkylaryl polyoxyethylene ethers, alkylaryl formaldehyde condensed polyoxyethylene ethers, block polymers using polyoxypropylene as a lipophilic group, and polyoxyethylene-polyoxypropylene copolymers.

The oxyacid is used to increase the dissolution stability of the metal compound in a metal salt aqueous solution.

The oxyacid is a hydroxycarboxylic acid, and specific examples thereof include, for example, citric acid, malic acid, tartaric acid, tartronic acid, glyceric acid, hydroxybutyric acid, hydroxy acrylic acid, lactic acid, and glycolic acid.

Meanwhile, it is necessary to control the coagulation between metal ingredients and increase the dispersion in order to improve the desulfurization activity. To this end, the stability of the metal salt aqueous solution may be improved to some extent by adding oxyacid to the additive, however, there is still a problem that the catalytic ability is reduced because the coagulation between metal ingredients cannot be sufficiently controlled.

In this regard, step S40-1 an example of further adding precipitated carbonate to the additive.

A fine coating film is formed on the metal salt by adding the precipitated carbonate to increase the repulsion between the metal salts, thereby controlling the coagulation phenomenon. Preferably, it is reasonable that the metal salt and precipitated carbonate are stored as a mixture and added as a mixture to form an aqueous solution, so as to prevent an agglomeration phenomenon between particles during storage.

The precipitated carbonate includes precipitated crystalline and/or amorphous carbonate compounds as metastable carbonate compounds precipitated from water, such as alkaline earth metal-containing water like brine.

The desulfurization catalyst mixes the above composition and then precipitates and stabilizes the mixed composition for a certain period of time without separating and drying the precipitate, and may be used as a solid desulfurization catalyst added during combustion when the precipitate is separated and dried. In addition, the liquid composition remaining after separating the precipitate may be used as a liquid desulfurization catalyst.

Hereinafter, preferred embodiments of the absorbent will be described based on experimental examples.

### Example 1

First, 1,350 g of yellow-state illite crushed to 1,000 mesh is added to 15 L of RO water heated to 60° C. and is stirred for 30 minutes. Thereafter, 150 g of sodium tetraborate is added and stirred for 10 minutes to dissolve sufficiently (the temperature drops by approximately 10° C.), and then 300 g of sodium hydroxide is slowly added and stirred. When a temperature of a reaction solution reaches 70° C. due to dilution heat, 300 g of water glass is added and stirred for 1 hour.

The reaction solution is stirred until the temperature naturally decreases to room temperature. The stirring is stopped at room temperature, the reaction solution is placed overnight, and the supernatant is filtered to prepare an adsorbent. In addition, the precipitate is separated to prepare a desulfurization catalyst.

### Example 2

First, 540 g of yellow-state illite crushed to 325 mesh is added to 6 L of RO water heated to 60° C. and is stirred for 30 minutes. Thereafter, 300 g of sodium tetraborate is added and stirred for 30 minutes (the temperature of the reaction solution drops by approximately 20° C.). When the temperature of the reaction solution becomes 40° C. or lower in a natural state, 900 g of sodium hydroxide is slowly added and stirred. When the temperature of the reaction solution reaches 80° C. by dilution heat, 300 g of water glass is added and stirred for 1 hour.

After the reaction temperature naturally drops below 60° C., 90 g of hydrogen peroxide is added and then stirred until the reaction solution reaches room temperature. The stirring is stopped at room temperature, the reaction solution is placed overnight, and the supernatant is filtered to prepare an adsorbent. In addition, the precipitate is separated to prepare a desulfurization catalyst.

### <Exhaust Gas Analysis Equipment>

NOVA 9K (MRU Emission Monitoring System, Germany) is used, and the sensors, measurement ranges, and resolutions for each target to be measured are as shown below.
O₂(E.C): 0˜21 Vol %/0.2%
CO₂(NDIR): 0˜40 Vol %/0.3%
SO₂(E.C): 0˜2,000 ppm/5 ppm
EC: Electrochemical sensor, NDIR: Non-dispersive infrared sensor

### <Exhaust Gas Analysis Scheme>

SO₂ analysis

The charcoal briquette is put in the Meseta Harry wood-burning stove and ignited, 1 kg of brown coal is added 5 minutes later and combustion begins. After about 15 minutes, 3 kg of brown coal, to which 100 g of the liquid desulfurization catalyst prepared in Example 1 is uniformly sprayed, is added and combustion begins fully.

In order to absorb some of the exhaust gas exhausted through a chimney, a hole is drilled in a middle part of the chimney and connected with a silicone hose, and a gap is completely sealed by silicone. Exhaust gas is sucked through a diaphragm pump to adjust a flow meter to 35 L/min, and blown into a reaction bath among experimental devices through an In-Let tube of a gas trap adapter. The exhaust gas discharged through an Out-Let tube of the gas trap adapter is connected to NOVA 9K and then an amount of SO₂ is measured.
CO₂ analysis

An N₂ bombe and a CO₂ bombe with which a heating device is attached are prepared, Flow Meters are adjusted to N₂ 30 L/min and CO₂ 5 L/min, and gas is mixed through a Y adapter and blown into a reaction bath through an In-Let tube of a gastrap adapter. A CO₂ concentration is measured at an Out-Let of the gastrap adapter, 1 L of the CO₂ chemical adsorbent prepared in Example 2 is introduced into the reaction bath through a dropping funnel, and the CO₂ concentration is measured again.

### <Experimental Example 1> Measurement on SOx Removal Ability

After brown coal is combusted in the wood-burning stove, the generated amount of SOx is measured and the reduced amount of SOx is measured in the exhaust gas using the experimental devices.

The experimental result is shown in FIG. 3. As shown in the graph, it can be seen that the SOx reduction ability is exhibited by the action of the absorbent of Example 1 from approximately 37 minutes to 91 minutes.

### <Experimental Example 2> Measurement on CO₂ Removal Ability

In the experimental devices, 14% CO₂ Gas is adjusted to be injected into the main reactor through the N₂ bombe and the CO₂ bombe, 1 L of the CO₂ chemical absorbent prepared in Example 2 is added and allowed to pass through the introduced gas, and then the reduced amount of CO₂ is measured.

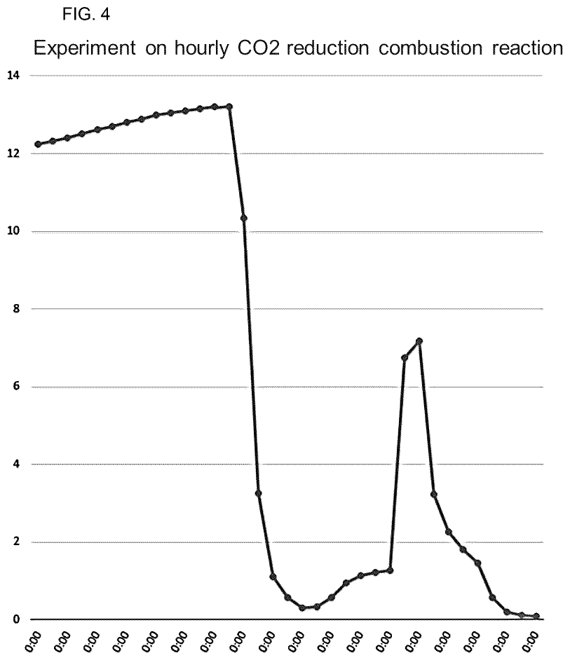

The experimental result is shown in FIG. 4. a first descending curve on the graph indicates that Example 2 is injected and CO₂ is reduced. While CO₂ reduction was taking place, the ascending curve is caused by opening a reactor lid to introduce external air, thereby increasing CO₂. Thereafter, although not mentioned in the present invention, it can be seen that CO₂ is reduced again as a result of introducing a regenerated absorbent obtained by regenerating the absorbent of Example 2 used previously.

### <Experimental Example 3> Measurement on Desulfurization Catalytic Ability

In order to measure the sulfur content in the exhaust gas during combustion by applying the desulfurization catalyst prepared in each example, an experiment is conducted using a drop tube furnace (DTF) which is a coal combustion characteristic experimental facility. An average total amount of SO₂ emissions from the exhaust gas of each example is measured during the combustion process under the operating condition of 1,100° C., and the results are shown in Table 1 below. The comparative example is a desulfurization catalyst sold as a conventional product.

TABLE 1

| Unit | Comparative Example | Example 1 | Example 2 |
|---|---|---|---|
| ppm | 296 | 294 | 297 |

As shown in the above table, it can be seen that similar results are derived from the examples and the comparative example. In other words, it can be seen that the desulfurization catalyst manufactured by the manufacturing method of the present invention exhibits the catalytic ability similar to those of existing products.

As described above, although the present invention has been described by the limited embodiments and drawings, the present invention is not limited to the embodiments, and it will be understood by a person having ordinary skill in the art that various changes and modifications may be carried out from the above-mentioned description.

1. A method for producing a carbon dioxide absorbent and a desulfurization catalyst, the method comprising:
(S10) introducing an illite powder into a reaction bath storing water heated to 40° C. to 100° C., followed by stirring;
(S20) introducing sodium hydroxide into the reaction bath, followed by stirring;
(S30) separating and filtering a supernatant from the reaction bath; and
(S40) separating a precipitate from the reaction bath.

2. The method of claim 1, further comprising:
adding sodium tetraborate to the reaction bath, followed by stirring (S10-1), before step S20.

3. The method of claim 2, further comprising:
adding water glass to the reaction bath, followed by stirring (S20-1), after step S20.

4. The method of claim 3, further comprising:
adding hydrogen peroxide to the reaction bath, followed by stirring (S20-2), after step S20-1.

5. The method of claim 1, further comprising:
mixing an additive including a surfactant and an oxyacid into the separated precipitate (S40-1), after step S40.

6. The method of claim 5, wherein step S40-1 includes further adding precipitated carbonate.
